(19) United States
(12) Patent Application Publication
(10) Pub. No.: US 2009/0241039 A1
(43) Pub. Date: Sep. 24, 2009

(54) SYSTEM AND METHOD FOR AVATAR VIEWING

(76) Inventors: Leonardo William Estevez, Rowlett, TX (US); Marion Lineberry, Dallas, TX (US)

Correspondence Address: TEXAS INSTRUMENTS INCORPORATED, P O BOX 655474, M/S 3999, DALLAS, TX, 75265, US

(21) Appl. No.: 12/407,725

(22) Filed: Mar. 19, 2009

Related U.S. Application Data
(60) Provisional application No. 61/037,867, filed on Mar. 19, 2008.

(51) Int. Cl. G06F 3/048

(52) U.S. Cl. 715/757

(57) ABSTRACT

An aspect of the present invention enables users of social networks to view other users' avatars while imaging those users on their mobile device. The mobile may be able to detect faces in a current image. The device then connects to the social network via some internet interface and asks the social network to find the users being imaged. The mobile device should also be able to connect to other mobile devices to gain permission to share avatar information.

The present application claims benefit under 35 U.S.C, §119 (e) to U.S. provisional patent application 61/037,867, filed Mar. 19, 2008, the entire disclosure of which is incorporated herein by reference.

### BACKGROUND

Mobile devices come in many different varieties and with many different functions.

Mobile devices are also now able to connect to social networks. Social networks are a form of service provider that allows users to post information about themselves and to view information about others. Social networks are mainly used to connect to other users from around the world. Each network has its own functions and features. Some networks allow users to communicate, share information (including data files) and play games.

### BRIEF SUMMARY

It is an object of the present invention to provide a system and method that allows a user to view their friends' “avatars” on a mobile device. An avatar is a computer user's representation of himself or alter ego, whether in the form of a three-dimensional model used in computer games, a two-dimensional icon or picture used on Internet forums and other communities or a text construct. An avatar is an “object,” whether static or dynamic, that represents the embodiment of the user. This avatar information may be stored in a social network database.

An aspect of the present invention enables users of social networks to view other users' avatars while imaging those users on their mobile device. The mobile may be able to detect faces in a current image. The device then connects to the social network via some internet interface and asks the social network to find the users being imaged. The mobile device should also be able to connect to other mobile devices to gain permission to share avatar information.

In accordance with an aspect of the present invention, a communication device may be used with a communication system including another communication device that is being used by a person, a communication network and a database. The communication device may be used by a user. The communication system is operable to enable communication between the communication device and the database. The database has personal data stored therein corresponding to the user. The personal data includes avatar data corresponding to an avatar. The communication device comprises a transmitter portion, a receiver portion, an imaging portion, a display portion and a controller portion. The transmitter portion is operable to transmit first transmission data to the database and to transmit second transmission data to the other communication device. The receiver portion is operable to receive first reception data from the database and to receive second reception data from the other communication device. The imaging portion is operable to obtain an image of the person. The display portion is operable to display the image of the person to the user. The controller portion is operable to enable the imaging portion to obtain the image of the person, to enable the display portion to display the image of the person, to enable the transmitter portion to transmit the first transmission data to the sender provider, to enable the display portion to display an indication based on the first reception data, to make a selection based on the indication and to provide an avatar signal to the display portion based on the selection. The display portion is further operable to superimpose an image of the avatar, based on the avatar signal, onto the image of the person.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a communication system 100 for displaying an avatar in accordance with an aspect of the present invention;

FIG. 2 is an exploded view of communication device 108 of FIG. 1;

FIG. 3 is a flowchart explaining an example method of operating a system in accordance with an aspect of the present invention;

FIG. 4 is an example of a communication device 108;

FIG. 5 is an exploded view of an example service provider 116 in accordance with an aspect of the present invention; and

FIG. 6 is an example image of a person having an avatar superimposed thereon in accordance with an aspect of the present invention.

### DETAILED DESCRIPTION

In accordance with an aspect of the present invention, an avatar application enables wirelessly connected users to view a superimposed avatar with a real time video image of another person. For example, a first person may have a mobile communication device, e.g., a cell phone, which includes a video imaging system, e.g., a video camera and display. This person may image a second person with the mobile communication device so as to view a video image of the second person. The image of the second person is used to obtain an avatar corresponding to the second person. The avatar is provided to the mobile communication device so as to be superimposed onto the image of the second person. As such, the first person may view the video image of the second person with the avatar superimposed thereon. In one example, the avatar may include an animal that is sitting on the image of the shoulder of the second person.

By way of example, suppose a person walks into a social setting that includes many people, some of whom are friends. In accordance with an aspect of the present invention, this person and some of the friends may be able to display, via their communication devices (cell phones, PDAs, etc.), images of one another concurrently with their respective avatars. For example, a user may image people in the room, and the user's communication device would be operable to identify the friends in the image, obtain their respective avatar information, and display the avatar(s) in the image.

In one embodiment of a system and method in accordance with the present invention, a user's communication device may have an avatar viewing application, wherein the user can view other people in combination with the avatars of the other people, respectively. If a user's communication device does not have an avatar viewing application, then the user may install avatar software to provide an avatar viewing application. In any event, once enabled, the user may then create or download an avatar animation file into the communication device. The user may then configure the communication device to join an avatar enabled network inside the avatar viewing application when the avatar viewing application is launched. The user may then launch the avatar viewing application and video preview the closest person of interest until an indication, such as for example a flashing box appearing around the image of the face of the closest person of interest, informs that user that a person of interest is located. By way of any known user interface, the user may then select this person for avatar viewing. The closest person of interest may similarly launch the avatar application and preview user until a flashing box appears around the image of the user's face. Similarly, the closest person of interest may select the user for avatar viewing.

In one embodiment, each communication device may include an indoor/outdoor GPS capability and face size information along with avatar information. Face size takes into account zoom and optical characteristics of an imaging portion, e.g., a camera, within each communication device. Matching GPS and face size, the user and the person of interest exchange model animation files. If there are more than one possible GPS/face size match at the same time, in some embodiments, the avatar viewing application selects the user with strongest received signal strength indication (RSSI). The user and the person of interest may then select one another.

The avatar viewing application may quickly scan for other “avatar” networks with threshold signal levels. If no other threshold RSSI networks exist, communication device may establish a connection with the network and waits for a request for model animation file exchange while providing an indication to the user, such as for example “waiting for request”.

Each avatar viewing application is operable to superimpose an avatar onto the image of the person being imaged. In some embodiments, the avatar is a still image. In some embodiments, the avatar is an animation. Further, the avatar may be superimposed onto the image of the person being imaged in a position relative to a portion of the image of the person being imaged. For example, in some embodiments, the avatar is an animation that is superimposed onto the image of the other person's left or right shoulder.

The avatar image may be displayed until one of the users terminates viewing. Such an action may terminate viewing for both parties. Further, an avatar may not be displayed unless active connections between both parties are maintained. For example, each avatar viewing application may continue to ping the server or the other mobile user during rendering at predetermined intervals.

The virtual avatar may only become visible via use of a communication device in accordance with an aspect of the present invention. Specifically, such a communication device would be able to perform the following four actions: 1) receive models, textures, animations or image files from the person wishing to reveal their virtual avatar; 2) determine relative location of person wishing to reveal their avatar or relative environment; 3) capture video and detect/track person's face in video—in some embodiments an algorithm may work without relative location information; and 4) render models, textures, animations or images and overlay them with respect to segmented person in captured video at appropriate scale, resolution, orientation, and position.

In some embodiments in accordance with an aspect of the present invention, a face detection algorithm may execute on a dedicated processor along with Sum of Absolute Difference (SAD) based tracking algorithms in order to determine real-time relative face rendering positions for avatar animations. A global SAD tracking algorithm may maintain an offscreen vector to left or right shoulder even after a locked face is no longer visible on the display. Determination of left or right shoulder location may be based on face scale and known properties of human anatomy.

Non-limiting examples of video rendering and overlaying include; three-dimensional rendering overlay with ambient specular information or two-dimensional overlay, which may be a two-dimensional representation of a three-dimensional animation with various real world assumptions. A two-dimensional overlay may be relative position indexed utilizing conventional three-dimensional languages, which enable both two-dimensional, and three-dimensional animations to be represented within a three-dimensional coordinate system over time.

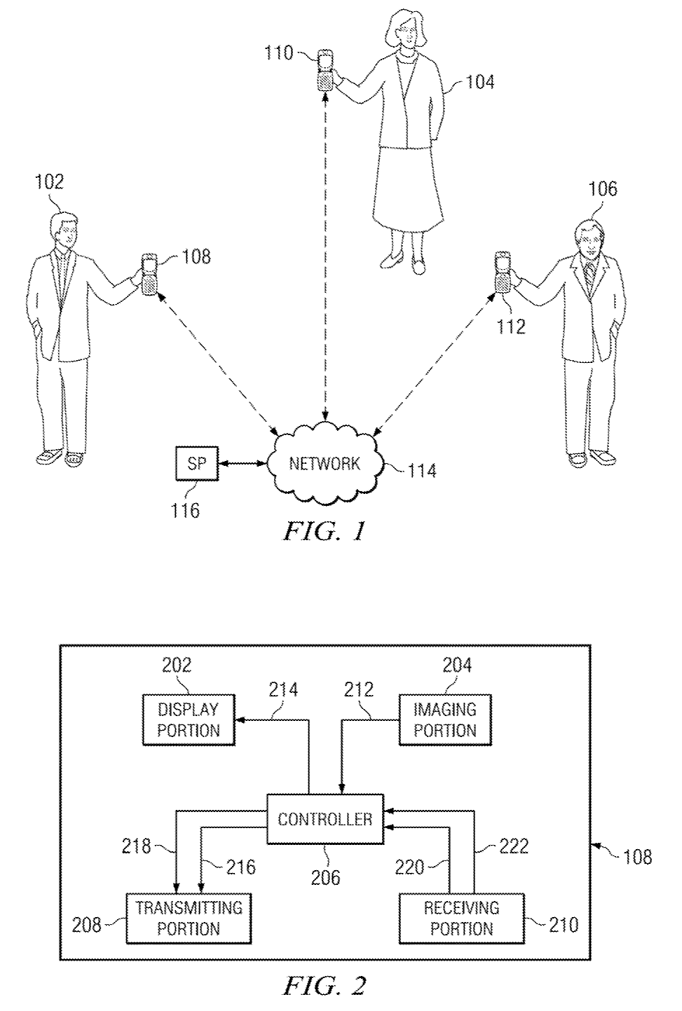

FIG. 1 illustrates a communication system 100 for displaying an avatar in accordance with an aspect of the present invention.

System 100 includes a communication device 108, a communication device 110, a communication device 112, a communication network 114 and a service provider. Communication device 108 is operable to be used by a user 102. Communication device 110 is operable to be used by a person 104. Communication device 112 is operable to be used by a person 106. Each of communication devices 108, 110 and 112 is operable to communicate with the other of communication devices 108, 110 and 112 via communication network 114.

FIG. 2 is an exploded view of communication device 108. As illustrated in the figure, communication device 108 includes a display portion 202, an imaging portion 204, a controller 206, a transmitting portion 208 and a receiving portion 210. In some embodiments, display portion 202, imaging portion 204, controller 206, transmitting portion 208 and receiving portion 210 are distinct elements. In some embodiments, at least one of display portion 202, imaging portion 204, controller 206, transmitting portion 208 and receiving portion 210 are a unitary element.

Imaging portion 204 is operable to obtain images, such as for example still images and video, and generate imaging data 212 based on the obtained images.

Display portion 202 is operable to display images. As described in more detail below, the images that display portion 202 is operable to display include still images and/or video of at least one of person 104 and 106, in addition to at least one of an avatar corresponding the at least one of person 104 and 106, respectively.

Transmitting portion 208 is operable to transmit data in order to communicate with network 114 or directly with communication device 110 or communication device 112. For example, in cases where communication device 108, communication device 110 and communication device 112 are cell phones, and where network 114 is a cell phone network, communication device 108 may transmit data to at least one of communication device 110 and communication device 112 via network 114. In cases where communication device 108, communication device 110 and communication device 112 are wireless communication devices, such as for example Wi-Fi devices, communication device 108 may directly transmit data to at least one of communication device 110 and communication device 112. The data that transmitting portion 208 is operable to transmit includes service provider request data 216 and communication device request data 218, as will be described in more detail below.

Receiving portion 210 is operable to receive data from network 114 or directly with communication device 110 or communication device 112. For example, in cases where communication device 108, communication device 110 and communication device 112 are cell phones, and where network 114 is a cell phone network, communication device 108 may receive data from at least one of communication device 110 and communication device 112 via network 114. In cases where communication device 108, communication device 110 and communication device 112 are wireless communication devices, such as for example Wi-Fi devices, communication device 108 may directly receive data from at least one of communication device 110 and communication device 112. The data that receiving portion 210 is operable to receive includes service provider data 220 and communication device data 222, as will be described in more detail below.

Controller 206 is operable to process data received by receiving portion 210, to process imaging data from imaging portion 204 to provide display data 214 to display portion 202 and provide data to transmitting portion 208 for transmission.

An example method of using system 100 in accordance with an aspect of the present invention will now be described with reference to FIGS. 1-3. In this example, user 104 has an avatar and user 102 would like to view an image user 104, wherein the image includes the avatar of user 104 superimposed thereon.

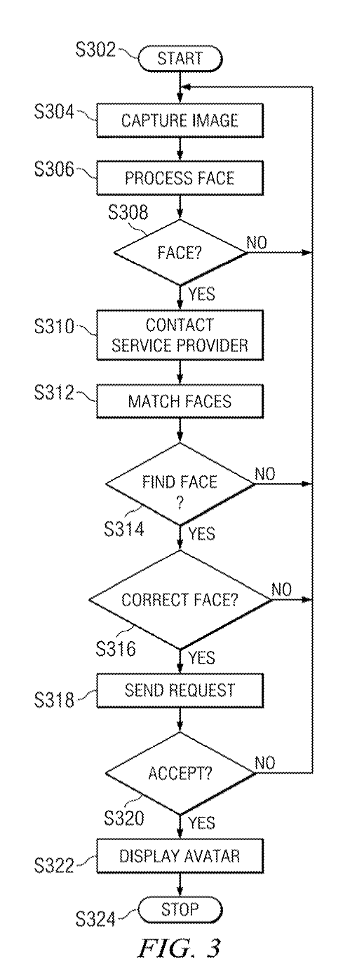

FIG. 3 is a flowchart explaining an example method of operating a system in accordance with an aspect of the present invention. As illustrated in the figure, process 300 starts (S302), and user 102 captures an image of person 104, via communication device 108 (S304).

For example, person 102 may hold communication device 108 such that imaging portion 204 can detect an image of person 104. In some embodiments, the image of person 104 is a static image, e.g., a picture. In some embodiments, the image of person 104 is a moving image, e.g., a movie.

Imaging portion 204 provides image data 212 corresponding to the detected image of person 104 to controller 206. Controller provides the image data 214 corresponding to the detected image of person 104 to display portion 202. Display portion 202 then displays an image corresponding to the image data. User 102 is then able to view the image, which corresponds to person 104.

In the embodiments discussed above, imaging portion provides the image data to controller 206, which then provides the image data to display portion 202. In other embodiments, imaging portion 204 provides the image data directly to display portion 202.

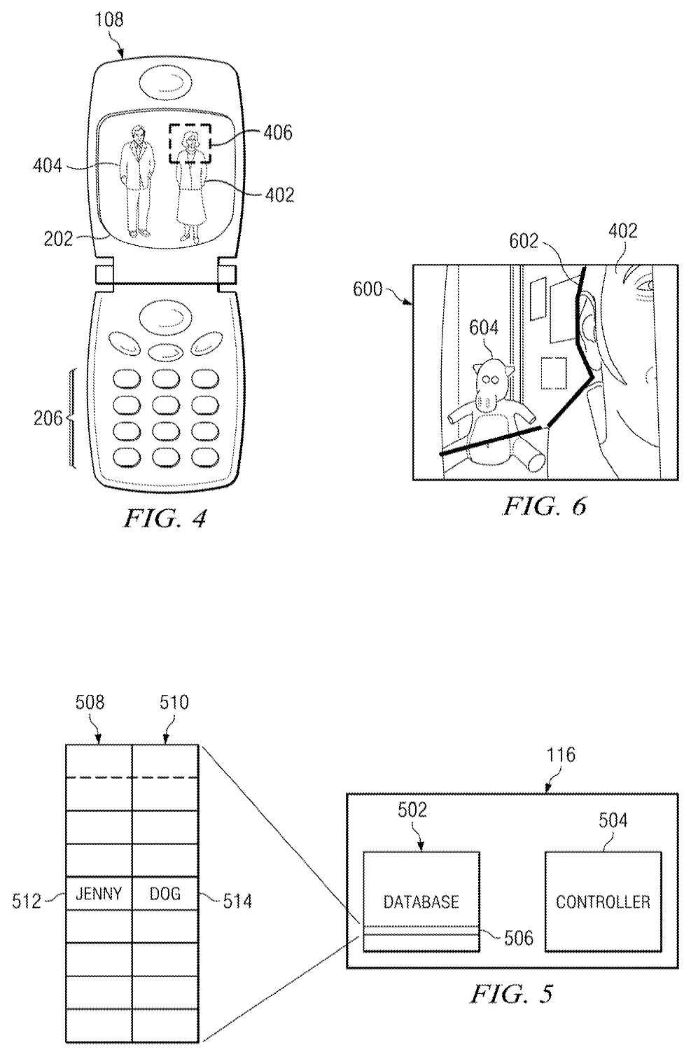

FIG. 4 is an example of a communication device 108. As illustrated in the figure, display portion 202, is disposed above controller 206. In this example, imaging portion 204 is disposed on the side of communication device 108 that is opposite to the side having display portion 202. Accordingly, when communication device 108 is oriented such that imaging portion 204 is facing person 104 and person 106, user 102 may view an image on display portion 202. In this example, display portion 202 shows an image 402 and an image 404, where image 402 corresponds to person 104 and image 404 corresponds to person 106.

Returning to FIG. 3, after the image corresponding to person 104 has been captured, a face portion of image data corresponding to the face portion of the detected image of person 104 is determined (S306). There are many conventional pattern or shape recognition algorithms that may be used with a system in accordance with an aspect to the present invention in order to detect a person's face within an image. Returning back to FIG. 4, in this example embodiment, the portion of the image indicated by the dotted box 406 is determined to be the image of the face of person 104.

Returning to FIG. 3, it is then determined whether an image of a face is within the detected image of person 104 (S308). If an image of a face is not within the detected image of person 104, the process returns to capture a new image (S304). In some other embodiments, if an image of a face is not within the detected image of person 104, the process may terminate (S300).

If an image of a face is determined to be within the detected image of person 104, a service provider is contacted (S310). An example service provider will now be described with reference to FIG. 5.

FIG. 5 illustrates an example service provider 116 that may be used in accordance with an aspect of the present invention. A service provider is an entity that provides a type of service to a number of users. In this example embodiment, service provider 116 is a social network.

Service provider 116 includes a database 502 and a controller 504. Controller 504 is used to access data from and store data into database 502 and to communicate with devices outside of service provider 116. Database 502 is created by a number of users entering in various types of data. In this example embodiment, database 502 includes a plurality of data entries for a plurality of users, respectively, of service provider 116. One of the entries is data portion 506, which corresponds to data for user 102.

In this example, data portion 506 includes two fields of data, a field listing contacts that includes family, friends and coworkers, which is referred to as a friends list 508 and a field listing avatars, which is referred to as an avatar list 510. Friends list 508 contains a data entry 512, which contains data corresponding to person 104. Non-limiting examples of the type of data within entry 512 include name, phone number address and an image of the face of person 104. Avatar list 510 contains a data entry 514, which contains data corresponding to the avatar of person 104. Non-limiting types of information within data entry 514 include an image of the avatar to be displayed and the location of the avatar to be displayed with reference to the image of the face of person 104.

Controller 206 instructs transmitting portion 208 to contact service provider 116. Transmitting portion 208 sends service provider request data 216, which includes data corresponding to the image indicated by the dotted box 406, to service provider 116, for example via network 114. Service provider 116 searches for a match to image of face 406 within friends list 508 (S312). Service provider 116 may determine a match to image of face 406 within friends list 508 using any conventional data matching technique. However specific example embodiments of matching an image of face 406 within friends list 508 will now be discussed.

In some embodiments, a determination of whether an imaged face matches a face within friends list 508 is based on specific parameters, non-limiting examples of which include face size, location and time.

With respect to face size, in some embodiments, controller 206 is operable to determine a distance from communication device 108 to person 104 based on the detected image of face 406 and the magnification of the optical system within imaging portion 204. Controller 206 may therefore calculate a size of the face of person 104. In this example embodiment, data portion 506 includes data entries corresponding to a face size for each person. Accordingly, the calculated size of face of person 104 may be used as search criteria within data portion 506 to find a matching face.

With respect to distance, in some embodiments, controller 206 is operable to provide GPS data corresponding to the location of user 102. In this example embodiment, data portion 506 includes data entries corresponding to an updatable current location for each person. Specifically, each person that subscribes to service provider 116 may update their respective data to include position information provided by a GPS system. The location of person 104 may be used as search criteria within data portion 506 to find a matching face.

With respect to time, in some embodiments, controller 206 is operable to timing data corresponding to the time a request is sent from communication device 108 to view an avatar. In this example embodiment, service provider may be able to limit the people searched within data portion 506 to those that have enabled an avatar application within a predetermined period of time. For example, presume that user 102 actuates an avatar application on communication device 108 to request to see the avatar of person 104, while viewing an image of both person 104 and person 106. Further, presume in this example, that only person 104 has additionally actuated an avatar application on communication device 110. Still further, presume that data portion 506 includes updatable data indicating whether a person is currently actuating an avatar application. In this embodiment, service provider 116 may be able to limit the search for matching faces to data corresponding to persons that have actuated an avatar application. Therefore, in this situation, the search would exclude data corresponding to person 106, in the event that person 106 even subscribed to service provider 116.

Of course, some embodiments in accordance with an aspect of the present invention are able to determine of whether an imaged face matches a face within friends list 508 based a combination of any of face size, location and time as discussed above.

Once the search has been completed, the results are sent as service provider data 220 from service provider 116 to receiving portion 210 via network 114.

Controller 206 uses service provider data 220 to determine if a face match has been found (S314). If there is no match, then the process may return to capturing a new image (S304). In some embodiments, if there is no match, the process may end (S324). If there is a match, it is then determined whether the matching images corresponds to person 104 (S316).

Controller 206 retrieves face image data within user data 512 and sends the face image data to display portion 202 to be displayed. Controller 206 may include any conventional user interface for user 102 to affirm whether a matching image corresponds to person 104. In one example, the matching image may be displayed on display portion 202 with a user prompting command such as “If this is the person, please press 1. If not, please press 2.” If user 102 determines that the displayed face image is not the image of the face corresponding to person 104, then the system may return to capturing an image (S304). In some embodiments, if user 102 determines that the displayed face image is not the image of the face corresponding to person 104, the system may or stop the process (S324).

If user 102 determines that the displayed face image is the image of the face corresponding to person 104, user 102 may request permission from person 104 to view the avatar of person 104 (S318). User 102 uses controller 206 to instruct transmitting portion 208 to send communication device request data 218 to communications device 110. Communication device request data 218 may be sent directly to communications device 110 or indirectly via network 114. Communication device request data 218 includes a request for permission from person 104 as to whether user 102 can display avatar of person 104.

Upon receiving communication device request data 218, communication device 110 informs person 104 that user 102 would like to view the avatar of person 104. A reply is sent from communications device 110 through network 114 to communications device 108. The reply is received by receiving portion 210 and communication device data 222 is sent to controller 206. It is then determined whether person 104 accepts the request of user 102 to view the avatar of person 104 (S320).

If person 104 denies the request of user 102 to view the avatar of person 104, or fails to grant the request, process 300 may return to capture a new image (S304). In other embodiments, if person 104 denies the request of user 102 to view the avatar of person 104, or fails to grant the request, the process may terminate (S324).

If person 104 grants the request of user 102 to view the avatar of person 104, then the avatar corresponding to person 104 is displayed (S322). Controller 206 instructs imaging portion 204 to superimpose the avatar corresponding to person 104 on the image of person 104. Person 102 may then view the image of person 104 with an avatar of corresponding to person 104 superimposed thereon.

FIG. 6 is an example image of a person having an avatar superimposed thereon in accordance with an aspect of the present invention. Image 600 includes image 402, person outline 602 and avatar image 604. In this example, person outline 602 corresponds to the outline of person 104. In this embodiment, the avatar is to be displayed on the right shoulder of user 104. Communication device 108 receives entry 514 from service provider 116 through network 114 using receiving portion 210. Communication device 108 then finds person outline 602 using any know system for outline detection, which may also be referred to as edge detection. Once person outline 602 has been found, avatar image 604 will be displayed in the correct position.

As for where the avatar is displayed, in some embodiments, avatar display information is contained in entry 514 and is provided to communication device 108 via network 114. Avatar display information may include placement of the avatar in relation to a predetermined portion of the image of the person, e.g., on the shoulder, on the head, etc. Further, avatar display information may include motion of the avatar in the event that the avatar is dynamic, e.g., flying around the head.

In cases where service provider 116 finds multiple possible face matches, in some embodiments of the present invention, user 102 may interlace with controller 206 to cycle through the potential faces until either a match is found, or it is determined there is not a correct match.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A communication device for use by a user and for use with a communication system including another communication device, a communication network and a database, the other communication device being operable for use by a person, the communication system being operable to enable communication between the other communication device and the database, the database having personal data stored therein corresponding to the user, the personal data including avatar data corresponding to an avatar, the avatar corresponding to the person, said communication device comprising:
a transmitter portion operable to transmit first transmission data to the database and to transmit second transmission data to the other communication device;
a receiver portion operable to receive first reception data from the database and to receive second reception data from the other communication device;
an imaging portion operable to obtain an image of the person;
a display portion operable to display the image of the person; and
a controller portion operable to enable said imaging portion to obtain the image of the person, to enable said display portion to display the image of the person, to enable said transmitter portion to transmit the first transmission data to the database, to enable said display portion to display an indication based on the first reception data, to make a selection based on the indication and to provide an avatar signal to said display portion based on the selection, and
wherein said display portion is further operable to superimpose an image of an avatar, based on the first reception data and the second reception data, which corresponds to the face of the person.

2. The communication device of claim 1, wherein said controller is operable to identify a portion of the image of the person as the face portion of the image, which corresponds to the face of the person.

3. The communication device of claim 2, wherein said controller is operable to determine a size of the face of the person based on the face portion of the image.

4. The communication device of claim 3, further comprising:
an input device,
wherein controller is further operable to enable said display portion to display a plurality of images, and
wherein said input device is operable to select one of the plurality of images as the indication.

5. The communication device of claim 1, wherein said display portion is further operable to display a moving image of the person.

6. The communication device of claim 5,
wherein the image of the avatar is a moving image of the avatar, and
wherein said display portion is further operable to superimpose the moving image of the avatar onto the moving image of the person.

7. The communication device of claim 5,
wherein the image of the avatar is a static image of the avatar, and
wherein said display portion is further operable to superimpose the static image of the avatar onto the moving image of the person.

8. An apparatus for use with a communication system including a first communication device, a communication network and second communication device, the first communication device being operable for use by a first user, the second communication device being operable for use by a second user, the first communication device having a transmitter portion, a receiver portion, an imaging portion, a display portion and a controller portion, the first communication device being operable to transmit first transmission data and to transmit second transmission data to the communication device, the receiver portion being operable to receive first reception data and to receive second reception data from the second communication device, the imaging portion being operable to obtain an image of the second user, the display portion being operable to display the image of the second user, the controller portion being operable to enable the imaging portion to obtain the image of the second user, to enable the display portion to display the image of the second user, to enable the transmitter portion to transmit the first transmission data, to enable the display portion to display an indication based on the first reception data, to make a selection based on the indication and to provide an avatar signal to the display portion based on the selection, the display portion being further operable to superimpose an image of an avatar, based on the avatar signal, onto the image of the second user, said apparatus comprising:
a controller operable to communicate with the first communication device and the second communication device via the communication network, to receive the first transmission data from the first communication device, to provide the first reception data to the receiver portion; and
a database operable to store personal data therein, the personal data including second user personal data corresponding to the second user, the second personal data including data corresponding to the avatar.

9. The apparatus of claim 8, wherein the second user personal data further includes facial data, which corresponds to an image of the face of the second user.

10. The apparatus of claim 9, wherein the facial data includes data corresponding to the size of the face of the second user.

11. The apparatus of claim 10, wherein the personal data further includes other personal data corresponding to another person.

12. The apparatus of claim 8, wherein the data corresponding to the avatar includes image data of the avatar.

13. The apparatus of claim 12, wherein the image data of the avatar comprises image data corresponding to a moving image of the avatar.

14. The apparatus of claim 12, wherein the image data of the avatar comprises image data corresponding to a static image of the avatar.

15. A method of using a communication system including a communication device, a communication network and a database, the communication device being operable for use by a person, the communication system being operable to enable communication between the communication device and the database, the database having personal data corresponding to an avatar, the avatar corresponding to the person, said method comprising:
transmitting first transmission data to the database;
transmitting second transmission data to the communication device;
receiving first reception data from the database;
receiving second reception data from the communication device;
obtaining an image of the person;
displaying the image of the person;
displaying an indication based on the first reception data;
making a selection based on the indication;
generating an avatar signal based on the selection, and
superimposing an image of the avatar, based on the avatar signal, onto the image of the person.

16. The method of claim 15, further comprising identifying a portion of the image of the person as the face portion of the image, which corresponds to the face of the person.

17. The method of claim 16, further comprising determining a size of the face of the person based on the face portion of the image.

18. The method of claim 17, wherein said displaying an indication based on the first reception data comprises displaying a plurality of images and selecting one of the plurality of images as the indication.

19. The method of claim 15, wherein said displaying the image of the person comprises displaying a moving image of the person.

20. The method of claim 19, wherein superimposing an image of the avatar, based on the avatar signal, onto the image of the person comprises superimpose a moving image of the avatar onto the moving image of the person.
